(19) United States
(12) Patent Application Publication
(10) Pub. No.: US 2011/0002788 A1
(43) Pub. Date: Jan. 6, 2011

(54) METHOD OF FORMING AN INTERNAL STRUCTURE WITHIN A HOLLOW COMPONENT

(75) Inventor: John H. Mason, Barnoldswick (GB)

Correspondence Address: OLIFF & BERRIDGE, PLC, P.O. BOX 320850, ALEXANDRIA, VA, 22320-4850, US

(73) Assignee: ROLLS-ROYCE PLC, London (GB)

(21) Appl. No.: 12/796,231

(22) Filed: Jun. 8, 2010

(30) Foreign Application Priority Data
Jul. 2, 2009 (GB) 0911416.6

(51) Int. Cl. F01D 5/14; B29C 65/00; B64C 3/00

(52) U.S. Cl. 416/223 R; 156/145; 156/497; 244/123.14

(57) ABSTRACT

A method of forming an internal structure within a hollow component (2), the component comprising first and second panels (4, 6) and at least one membrane (8; 10) disposed between the first and second panels (4, 6), the method comprising: selectively bonding the at least one membrane (8; 10) to the first and/or second panels (4, 6); inflating the component (2) by passing a pressurised fluid between the first and second panels (4, 6) such that the first and second panels (4, 6) are inflated into contact with a die assembly (38) and such that the membrane (8; 10) forms an internal structure between the first and second panels (4, 6); and deforming the internal structure by applying the pressurised fluid at a first pressure (P1) on one side of the membrane (8; 10) and at a second pressure (P2) on the other side of the membrane (8; 10).

This invention relates to a method of forming an internal structure within a hollow component, and particularly but not exclusively relates to applications of the method in hollow aerofoil components for turbomachines, and also to a membrane and die assembly for use in such a method.

It is known to manufacture hollow metallic aerofoils for example to be used as blades in a jet engine, and in particular fan blades for a turbomachine, by superplastic forming and diffusion bonding metallic panels, the panels forming pressure and suction surfaces of the blade. Such structures are widely used in the civil aerospace industry, for example in wide-chord fan blades, and may also be used in blinks (i.e. bladed disks), particularly in military applications. The metallic panels may include elementary metal, metal alloys and metal matrix composites and at least one of the metallic panels must be capable of superplastic extension. In one known process the surfaces of the panels to be joined are cleaned, and at least one surface of one or more of the panels is coated in preselected areas with a stop-off material, for example yttria, to prevent diffusion bonding. The panels are arranged in a stack and the edges of the panels are welded together, except where a pipe is welded to the panels, to form an assembly. The pipe enables a vacuum, or inert gas pressure, to be applied to the interior of the assembly. The assembly is placed in an autoclave and heated so as to “bake out” the binder from the material to prevent diffusion bonding. The assembly is then evacuated, using the pipe, and the pipe is sealed. The sealed assembly is placed in a pressure vessel and is heated and pressed to diffusion bond the panels together to form an integral structure. Diffusion bonding occurs when two mat surfaces are pressed together under temperature, time and pressure conditions that allow atom interchange across the interface. The first pipe is removed and a second pipe is fitted to the diffusion bonded assembly at the position where the first pipe was located. The integral structure is located between appropriately shaped dies and is placed within an autoclave. The integral structure and dies are heated and pressurised fluid is supplied through the second pipe into the interior of the integral structure to cause at least one of the panels to be superplastically formed to produce an article matching the shape of the dies.

In addition to the hollow assembly just described, it is also known to insert a membrane between the metallic panels prior to the above described process. The location of diffusion bonds between the membrane and the adjacent panels can be controlled by applying the stop-off material to preselected areas on each side of the membrane (or respective panels). When the aerofoil is subsequently expanded, the membrane adheres to the panels where the diffusion bond is allowed to form and thereby provides an internal structure. The internal structure is provided to increase the strength and stiffness of the aerofoil and also to prevent “panting” of the panels.

The assembly may be filled or part filled by a suitable material to provide damping of the structure and therefore to reduce vibration. A suitable material may be one which possesses viscoelastic properties. Viscoelasticity is a property of a solid or liquid which when deformed exhibits both viscous and elastic behaviour through the simultaneous dissipation and storage of mechanical energy. A known method is to introduce a viscoelastic material, for example a Huntsman™ syntactic damping paste or a similar product, into the cavity by injecting or otherwise introducing the material into some or all of the cavity. This technique may be applied in a hollow assembly wherein the cavity is smooth walled with no internal structure, see GB2371095 for example. In this configuration the viscoelastic material is restrained solely by the bond between the viscoelastic material and the walls of the cavity. If this bond is not sufficient to retain the viscoelastic material during working conditions, in particular due to centrifugal loading, then, since the viscoelastic material is a parasitic mass which is unable to support its own weight, the hydrostatic load of the unrestrained material may cause the blade to fail rapidly. Accordingly, the consequences of failure of this bond may be severe. It is therefore desirable to provide some form of means for retaining and restraining the viscoelastic material. An internal structure may be used to provide such a restraining or retaining effect on the injected material. However, by providing a rigid internal structure the benefits of damping the aerofoil may be reduced as the aerofoil is less flexible as a result of the internal structure. This may lead to additional problems where the aerofoil prematurely fatigues or cracks as a result of the reduced flexibility. Other configurations use internal ribs, which may be attached to alternate interior walls of the aerofoil but which are not connected to one another, see for example patent application number GB0713699.7. This configuration permits damping of the assembly whilst the non-re-entrant features still provide a means of retaining the injected material. However, the non-re-entrant features do not provide significant retention of the viscoelastic material against the centrifugal load, since the nature of viscoelastic materials results in a tendency to flow when loaded in tension.

Furthermore, the use of an internal structure to physically restrain the viscoelastic material inevitably adds weight to the aerofoil and thus increases the stresses on the aerofoil, in particular at the root of the aerofoil. This increases the blade off energy if the blade were to fail, which must be taken into account when designing the blade retention system. In addition the provision of complex internal structures increases manufacturing costs and lead times. It is therefore desirable to provide an improved method of restraining a viscoelastic material within a cavity which addresses some or all of the above problems associated with the prior art methods.

According to a first aspect of the present invention there is provided a method of forming an internal structure within a hollow component, the component comprising first and second panels and at least one membrane disposed between the first and second panels, the method comprising: selectively bonding the at least one membrane to the first and/or second panels; inflating the component by passing a pressurised fluid between the first and second panels such that the first and second panels are inflated into contact with a die assembly and such that the membrane forms an internal structure between the first and second panels; and deforming the internal structure by applying the pressurised fluid at a first pressure on one side of the membrane and at a second pressure on the other side of the membrane.

Deforming the internal structure may comprise deforming the internal structure in a direction which is substantially parallel to a plane of the first or second panel.

Selectively bonding may comprise applying a stop-off material to one or more portions of the at least one membrane and/or the first and second panels and diffusion bonding the component such that the membrane is bonded to the first and second panels except at the one or more portions where the stop-off material is applied.

The at least one membrane may be bonded to only one of the first and second panels.

Either side of the unbonded portion the membrane may be bonded to the first or second panel.

Each of the one or more unbonded portions may define a cavity between the membrane and the first or second panel.

During inflation the pressurised fluid may inflate the cavity between the membrane and the first or second panel so as to form the internal structure.

During deformation the first pressure may be applied to the cavity between the membrane and the first or second panel and the second pressure is applied between the membrane and the other of the first or second panel.

The first pressure may be greater than the second pressure.

The differential between the first pressure and the second pressure may cause the internal structure to be deformed.

The deformed internal structure may create a re-entrant feature.

The at least one membrane may comprise a first membrane and a second membrane and selectively bonding further may comprise applying a stop-off material to the one or both of the opposing surfaces of the first and second membranes to prevent bonding of the first membrane to the second membrane.

According to a second aspect of the present invention there is provided a method of forming an internal structure within a hollow component as claimed in any one of the preceding claims, wherein the die assembly comprises first and second dies each having a forming surface between which the aerofoil structure is placed; the method further comprising moving the die assembly to a second position and further inflating the component by passing a pressurised fluid between the first and second panels such that the first and second panels are inflated into contact with the die assembly in the second position, wherein the distance between at least a portion of the first and second dies is greater in the second position.

The forming surface of the first and/or second dies may have a section which is movable relative to the rest of the forming surface, and wherein moving the die assembly may comprise moving the movable section to the second position.

Selectively bonding may comprise selectively bonding the first membrane to the first panel and selectively bonding the second membrane to the second panel.

The first pressure may be applied between the first membrane and the first panel and between the second membrane and the second panel, and the second pressure may be applied between the first and second membranes.

The pressurised fluid when further inflating the component may be at a first pressure between the first membrane and the first panel and between the second membrane and the second panel, and at a second pressure between the first and second membranes. The first pressure may be lower than the second pressure.

The method may further comprise providing a damping material between the first and second membranes. The damping material may be a viscoelastic material.

The hollow component may be an aerofoil structure.

According to a another aspect of the present invention there is provided an aerofoil structure comprising first and second panels and first and second membranes disposed between the first and second panels, wherein the first membrane is selectively bonded to the first panel and the second membrane is selectively bonded to the second panel, wherein unbonded portions of the first and second membranes are formed into re-entrant features, the re-entrant features of the first or second membrane being spaced apart from the other of the first or second membrane.

The re-entrant features of the first and second membranes may be offset from one another.

Disposed between the first and second membranes may be a damping material. The damping material may be a viscoelastic material.

The aerofoil structure may be used in a turbomachine.

According to a another aspect of the present invention there is provided a membrane for a diffusion bonded and superplastically formed aerofoil structure, the membrane comprising: at least one channel formed in a surface of the membrane operable to receive a fluid.

The membrane may comprise a channel on both surfaces of the membrane.

The channel may extend from the perimeter of the membrane.

The channel may comprise a main channel extending from the perimeter of the membrane and a plurality of branches extending from the main channel.

The plurality of branches may extend perpendicularly to the main channel.

The branches may terminate in a radius.

The channel may be coated with a stop-off material which prevents diffusion bonding.

The membrane may be used in a turbomachine.

According to another aspect of the present invention there is provided die assembly for forming an aerofoil structure, the die assembly comprising: first and second dies each having a forming surface between which the aerofoil structure is placed; wherein the forming surface of the first and/or second dies has a section which is movable relative to the rest of the forming surface.

The movable section may be a central section of the forming surface.

The movable section may be movable toward and away from a central axis between the first and second dies.

The movable section may have a first and second position.

In the first position the aerofoil structure may be inflated into contact with the forming surfaces of the first and second dies to form an internal structure and wherein in the second position the aerofoil structure may be further inflated into contact with the forming surfaces of the first and second dies to take a final form of the aerofoil structure.

According to another aspect of the present invention there is provided a method of forming an internal structure within an aerofoil structure using a die assembly, the aerofoil structure comprising first and second panels and at least one membrane disposed between the first and second panels and the die assembly comprising first and second dies each having a forming surface; wherein the forming surface of the first and/or second dies has a section which is movable relative to the rest of the forming surface, the method comprising: selectively bonding the at least one membrane to the first and/or second panels; locating the aerofoil structure between the forming surfaces of the first and second dies with the movable section in a first position inflating the aerofoil structure by passing a pressurised fluid between the first and second panels such that the first and second panels are inflated into contact with the forming surfaces of the first and second dies and such that the membrane forms an internal structure between the first and second panels; deforming the internal structure by applying the pressurised fluid at a first pressure on one side of the membrane and at a second pressure on the other side of the membrane; moving the movable section to a second position and further inflating the aerofoil structure such that the first and second panels are inflated into contact with the forming surfaces of the first and second dies.

For a better understanding of the present invention, and to show more clearly how it may be carried into effect, reference will now be made, by way of example, to the accompanying drawings, in which:—

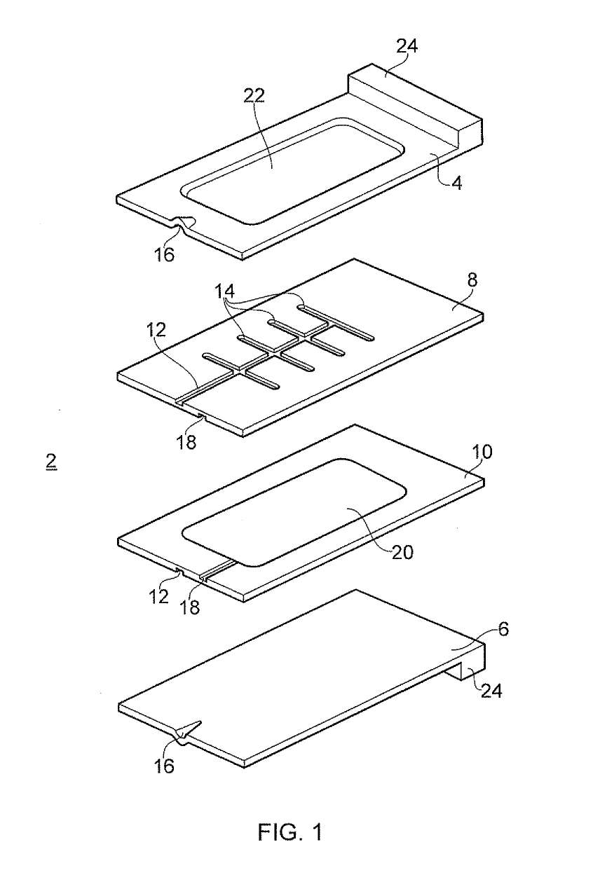

FIG. 1 shows an exploded view of the parts of a component, having a membrane in accordance with an aspect of the invention;

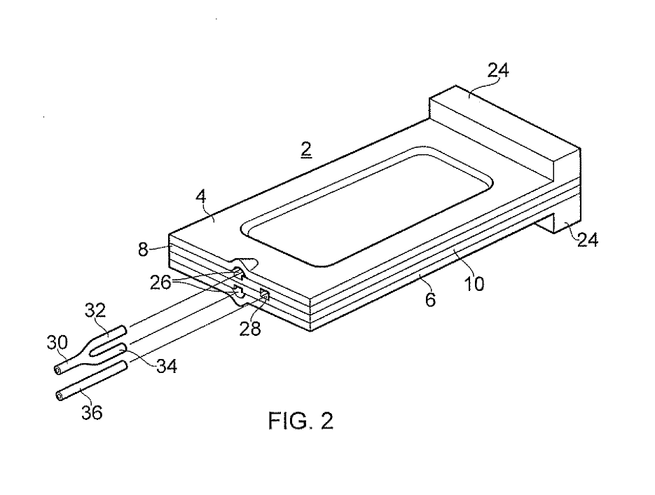

FIG. 2 shows a first stage of a method in accordance with another aspect of the invention, wherein the component of FIG. 1 has been assembled and diffusion bonded;

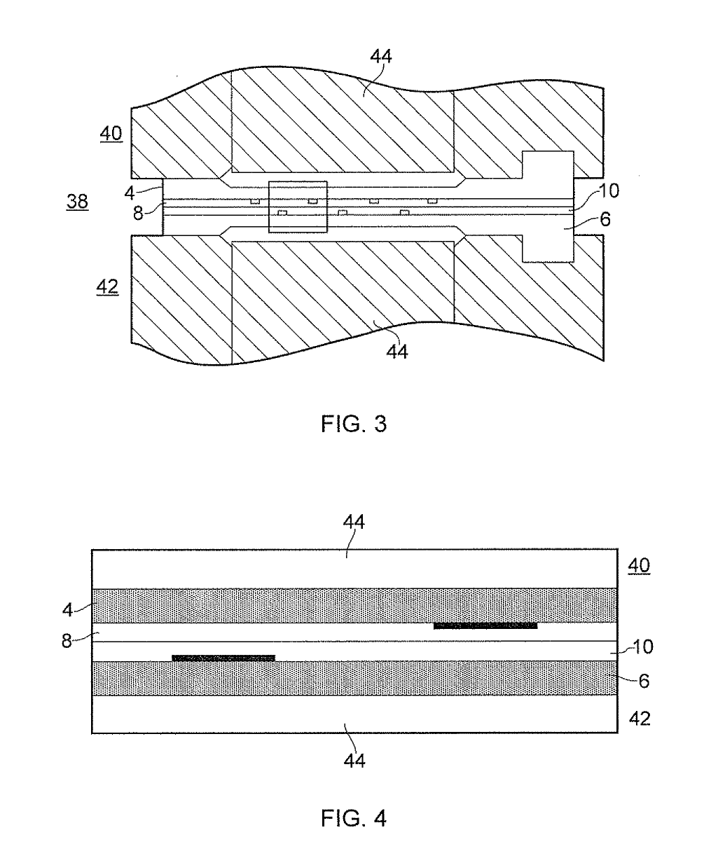

FIG. 3 shows a cross-sectional view of the component between a die assembly according to another aspect of the invention;

FIG. 4 shows an enlarged view of the dashed section of FIG. 3;

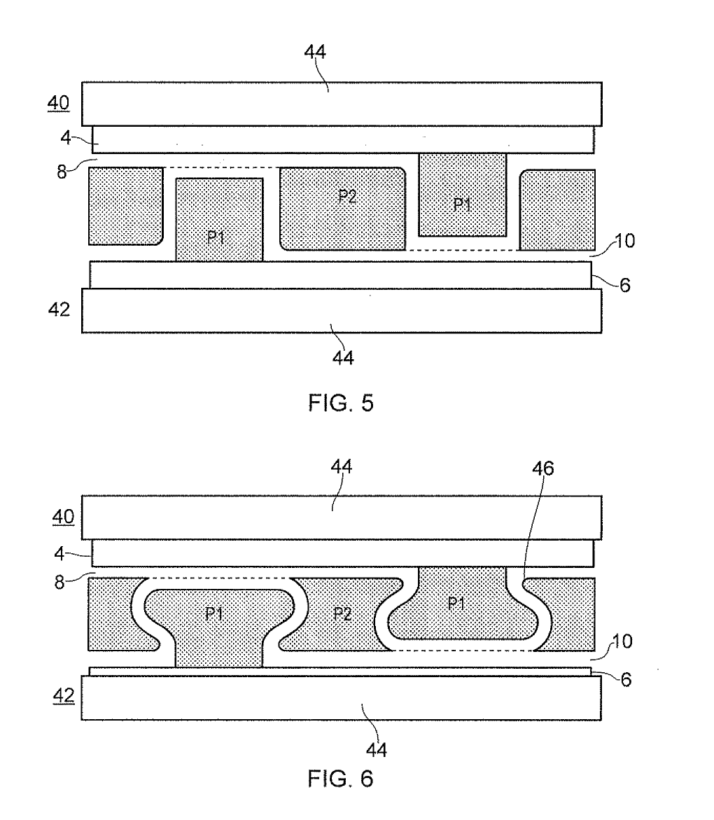

FIG. 5 shows the component following a first inflation stage of the method;

FIG. 6 shows the component following a second inflation stage of the method;

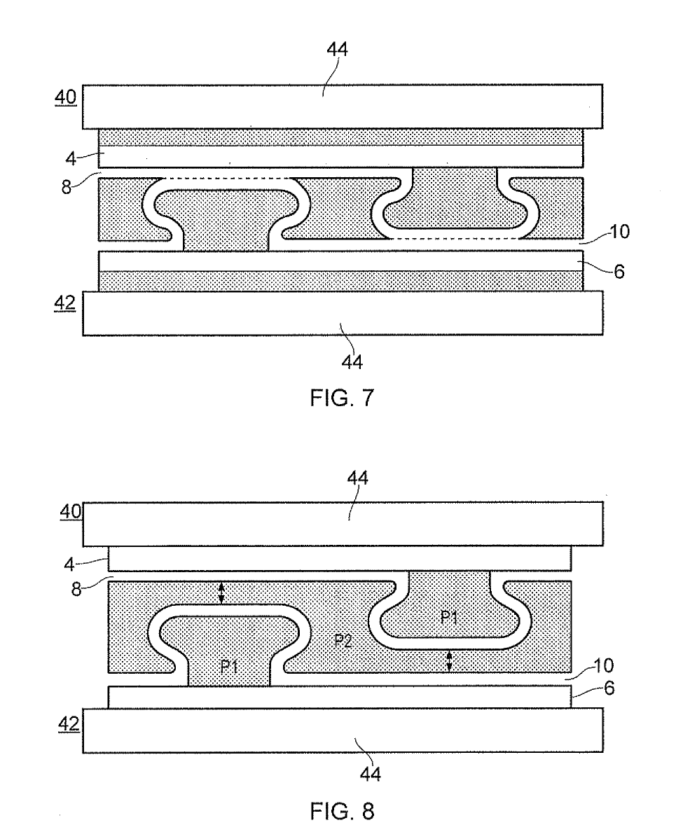

FIG. 7 shows the component following the second inflation stage with the die assembly having been moved to a second position;

FIG. 8 shows the component following a subsequent inflation stage of the method;

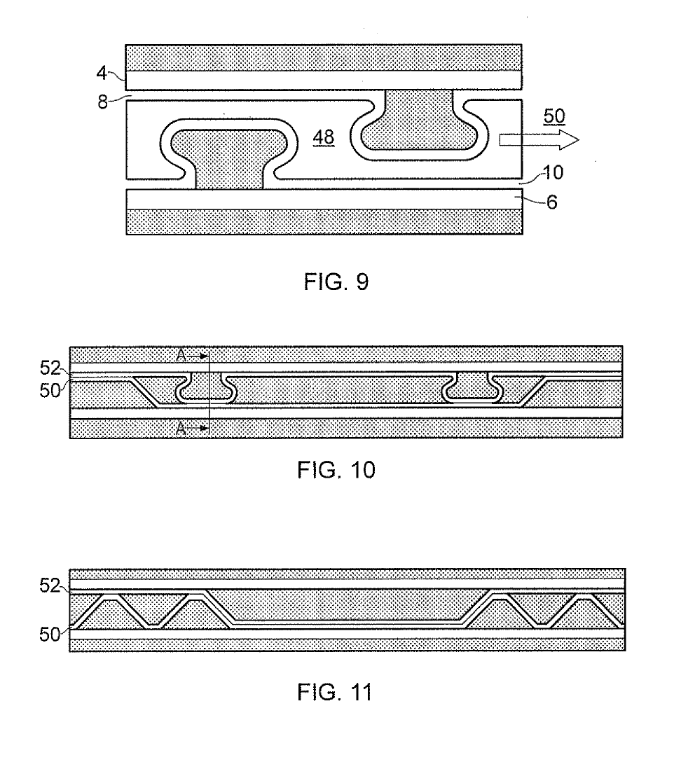

FIG. 9 shows the component following the subsequent inflation stage having a damping material within the cavity;

FIG. 10 shows an application of the invention; and

FIG. 11 shows a section through the plane A-A of FIG. 10.

With reference to FIG. 1, a component 2 according to the present invention comprises a first panel 4, a second panel 6, a first membrane 8 and a second membrane 10. The first and second membranes 8, 10 are disposed between the first and second panels 4, 6 with the first membrane 8 disposed adjacent the first panel 4 and the second membrane 10 adjacent the second panel 6.

The first and second membranes 8, 10 each comprise a channel 12 formed in a surface of the membrane, the channel extending from the perimeter of the membrane. Each channel has a plurality of branches 14 which extend perpendicularly from the channel 12, the branches each terminating in a radius. The channel 12 and branches 14 are coated with a stop-off material using any conventional coating method.

As described previously the stop-off material prevents the areas to which is applied from diffusion bonding and thus the channels 12 and branches 14 are not bonded to the first and second panels 4, 6 providing a fluid path through the channel 12 and to the branches 14. The surfaces of the first and second membranes 8, 10 with the channel 12 formed therein are disposed adjacent and facing the first and second panels 4, 6.

Instead of forming the channel 12 and branches 14 in the surface of the membrane, the stop-off material may be used to provide a fluid path by applying it to the surface of the membrane in a similar shape to that of the channel and branches 14. Fluid can then be forced down the unbonded paths created by the stop-off material. However, the channel 12 and branches 14 provide a more efficient fluid path and allow the stop-off material to be applied more accurately.

In the opposing surfaces of the first and second panels 4, 6, a first port 16 is formed. The first port 16 combines with the opening to the channel 12 at the perimeter of the membrane to provide an membrane-panel port 26, as shown in FIG. 2, suitable for receiving a fluid. The branches 14 of the first and second membranes 8, 10 are arranged such that the branches 14 of the first membrane 8 are offset from the branches (not shown) of the second membrane 10, as shown in FIG. 3.

The opposing surfaces of the first and second membranes 8, 10 are provided with a second port 18. The second ports of the first and second membranes 8, 10 combine to provide a membrane-membrane port 28, as shown in FIG. 2, suitable for receiving a fluid. The opposing surfaces of the first and/or second membranes 8, 10 are coated with the stop-off material over an area 20 to prevent diffusion bonding of the first and second membranes 8, 10 at the area 20. The second port 18 extends from the perimeter of the membrane to the area 20 and thus provides fluidic coupling between the exterior of the membrane and the area 20. The area 20 of the first and second membranes 8, 10 surrounds the area bounded by the branches 14, such that the ends of the branches 14 extend tangentially to the perimeter of the area 20. Similarly to the channel 12 and branches 14, the area 20 may be recessed slightly to provide a more efficient fluid path and to allow the stop-off material to be applied more accurately.

The membrane-panel port 26 and membrane-membrane port 28 are coated with the stop off material to prevent bonding and to maintain a fluid entry between the adjacent parts.

The first and second panels 4, 6 each comprise a relief formed in a portion of the exterior surface of the panel, such that the portion of the panel is thinner than the rest of the panel. The relief 22 is approximately the same dimensions as the area 20 and is coincident with the area 20.

Alternatively, a single membrane may be used having the channel and branch arrangement described above. The membrane may have a channel and plurality of branches formed on both of its surfaces. The branches formed in the one surface of the membrane are offset from the branches formed in the opposite surface of the membrane. Alternatively, the branch channel arrangement can be provided on one side only of the membrane with the other side containing one or more channels which permit gas to enter between the membrane and the panel.

The first and second panels 4, 6 may be suction and pressure panels of an aerofoil structure, in particular a blade for a turbomachine, such as a compressor fan blade. Each of the first and second panels comprise a root block which are joined to form the root of the aerofoil structure for attachment to a hub.

FIG. 2 shows the component 2 having been assembled and diffusion bonded as described previously. The first and second membranes 8, 10 are bonded to one another and the first and second membranes 8, 10 bonded to the first and second panels 4, 6 except where the stop-off material has been applied, i.e. the area 20 between the first and second membranes 8, 10, and the channel 12 and branches 14 between the first and second membranes 8, 10 and the first and second panels 4, 6.

A first pipe 30 is attached, for example by welding, to the membrane-panel ports 26 and second pipe 36 is attached to the membrane-membrane port 28. The first pipe 30 is bifurcated into first and second branches 32 and 34. The first branch 32 is connected to the membrane-panel port 26 between the first panel 4 and first membrane 8 and the second branch 34 is connected to the membrane-panel port 26 between the second panel 6 and second membrane 10. The first pipe 30 therefore allows a pressurised fluid (typically argon) to enter the cavities defined between both the first membrane 8 and the first panel 4 and also the second membrane 10 and the second panel 6 (the membrane-panel cavities). The second pipe 36 allows a pressurised fluid to enter the cavity defined between the first and second membranes 8, 10 (the membrane-membrane cavity).

The first and second pipes 30, 36 are each connected to a separate fluid management system which supplies the pressurised fluid and is capable of pressuring and venting the cavities. Due to the bifurcated nature of the first pipe 30, the pressure of the fluid supplied to the separate cavities is equal. If this is not desired, for example if a different geometry was required for the first and second membranes 8, 10 and/or first and second panels 4, 6, a third pipe could be used to connect a third fluid management system thus providing a separate supply for each of the cavities.

With the first and second pipes 30, 32 (and third pipe) attached, the component 2 is placed in a die assembly 38, which is capable of heating the component 2 to sufficient temperature to allow superplastic forming. The die assembly comprises a first die 40 and a second die 42 between which the component 2 is disposed. Each of the first and second dies 40, 42 comprise a central section 44 which is movable relative to the rest of the die, toward and away from the component 2 disposed between the dies. The central movable sections 44 may be moved by a hydraulic actuator or other conventional actuation means.

The central movable sections 44 of the first and second dies 40, 42 are initially located in a first position, wherein a gap is left between the relief 22 of the first and second panels 4, 6 and the surface of the central movable sections 44.

The component 2 is heated and a pressurised fluid is supplied into the membrane-panel ports 26 and membrane-membrane port 28 simultaneously. The pressurised fluid passes down the cavity formed by the channels 12 and branches 14 and also the cavity between the first and second membranes over the area 20. The pressure of the fluid in the membrane-panel cavities, P₁, is approximately equal to the pressure of the fluid in the membrane-membrane cavity, P₂.

The unbonded branches 14 are formed such that they are forced against the other membrane and thus cause the first and second panels to be inflated into contact with the central movable sections 44 of the first and second dies 40, 42, as shown in FIG. 5. The first and second membranes 8, 10 form an internal structure disposed between the first and second panels 4, 6.

The formation of the internal structure is facilitated by the channel 12 and branches 14 since the membrane is thinner at the location of these features.

FIG. 6 shows a second stage of the inflation process in which the internal structure created by the first and second membranes 8, 10 is deformed. In this second stage, the component 2 is restrained by the die assembly 38 and a pressure differential is created between the membrane-panel cavities and membrane-membrane cavity. The pressure, P₁, of the fluid supplied to the membrane-panel cavities is greater than the pressure, P₂, of the fluid supplied to the membrane-membrane cavity. Since the component is restrained by the die assembly 38, the pressure differential causes the internal structure formed by the first and second membranes 8, 10 to be deformed in a direction which is substantially parallel to the plane of the first or second panels 4, 6. Once the membrane has been deformed sufficiently, the fluid pressures P₁ and P₂ are equalised and the geometry of the membranes are then fixed.

The deformation of the internal structure creates re-entrant features within the component 2. The re-entrant features have a profile as shown in FIG. 6, wherein the unbonded portion of the membrane curves back over the bonded portions of the membrane which are either side of the unbonded portion. The membrane curves back with a small internal radius 46.

FIG. 7 shows a subsequent inflation stage wherein the central movable sections 44 of the first and second dies 40, 42 are moved to a second position which is further away from the component 2 so that the first and second panels 4, 6 are no longer in contact with the die assembly 38. The pressure P₂ in the membrane-membrane cavity is increased such that the first and second panels are forced into contact with the central movable sections 44 in the second position, thus creating a gap between the first and second membranes 8, 10, as shown in FIG. 8. The pressure P₁ is maintained at a lower pressure than P₂ during this stage to ensure that the re-entrant features are not further deformed.

As an alternative to the die assembly 38, first and second die assemblies could be used, the first and second die assemblies having dies arranged in the first and second positions respectively. In this arrangement, the component 2 would be transferred from the first die assembly to the second die assembly for the inflation stage shown in FIGS. 7 and 8. However the die assembly 38 would increase the efficiency and speed of the process.

Once the component 2 has been inflated by the pressurized fluid to produce the final geometry shown in FIG. 8, the membrane-membrane cavity is filled with a damping material 48, particularly a viscoelastic material, as shown in FIG. 9. The damping material may be a polymer, for example a Huntsman™ syntactic damping paste or a similar product.

In use, the damping material 48 is restrained by the re-entrant features. The left hand side of the component 2 shown in FIG. 9 is the root end of the aerofoil structure and the right hand side is the tip end of the aerofoil structure. In the application as a blade for a turbomachine, the rotation of the blade creates a centrifugal load in the direction of the arrow 50. The centrifugal load is opposed by the re-entrant features and thus prevents the damping material from flowing within the cavity. If allowed to do so, the damping material would quickly cause the blade to fail. The internal radius 46 dissipates stresses created when the re-entrant feature is acting to restrain the damping material.

The method of the present invention uses simple membrane sheets, which are relatively inexpensive to manufacture, to create re-entrant features. This has not previously been possible. Advantageously, the re-entrant features are created within existing process capabilities.

The formation of the channel 12 and branches 14 within the surface of the membrane provides an open fluid path into the cavity and thus gives a more efficient passage of fluid during the initial inflation of the component. In addition, the stop-off material can be applied very accurately within the recesses of the channel 12 and branches 14. This eliminates alignment issues between the stop-off material and the component which is a common problem when applying the stop-off material.

The re-entrant features of the invention could be accommodated into any hollow structure that it manufactured from a material that supports super plastic forming. For example, the invention could be incorporated into large hollow civil fan blades, where it could be applied locally to damp areas that are susceptible to unwanted vibrations. These fan blades typically have a warren girder structure formed by a single membrane. The warren girder structure may be truncated in the areas to be damped by bonding the warren girder membrane 50 to the first or second panels, as shown in FIG. 10. A membrane 52, which is otherwise bonded to the other of the first or second panels, has one or more unbonded sections in the truncated area. These unbonded sections may be inflated and deformed in accordance with the method described above to form re-entrant features in the truncated area. The re-entrant features are formed perpendicular to the axis of the centrifugal load, with the tip and root ends being at either side of FIG. 10.

FIG. 11 shows a cross-section through the plane A-A of FIG. 10. As shown the warren girder membrane has a leading edge warren girder structure and a trailing edge warren girder structure either side of the truncated area, which run from the root end of the blade to the tip end of the blade. The re-entrant feature is inflated against the leading and trailing edge warren girder structures such that an enclosed cavity 54 is formed by the re-entrant feature. This enclosed cavity 54 is filled with a damping material, particularly a viscoelastic material, as described previously.

In addition to retaining a damping material, the invention could also be used to provide additional strength and rigidity to hollow structures. Furthermore, the re-entrant features could be used to carry cooling fluids inside static structures such as exhaust heat shields, or heated fluids to prevent ice formation.

To avoid unnecessary duplication of effort and repetition of text in the specification, certain features are described in relation to only one or several aspects or embodiments of the invention. However, it is to be understood that, where it is technically possible, features described in relation to any aspect or embodiment of the invention may also be used with any other aspect or embodiment of the invention.

1. A method of forming an internal structure within a hollow component, the component comprising first and second panels and at least one membrane disposed between the first and second panels, the method comprising:
selectively bonding the at least one membrane to the first and/or second panels;
inflating the component by passing a pressurised fluid between the first and second panels such that the first and second panels are inflated into contact with a die assembly and such that the membrane forms an internal structure between the first and second panels; and
deforming the internal structure by applying the pressurised fluid at a first pressure on one side of the membrane and at a second pressure on the other side of the membrane.

2. A method of forming an internal structure within a hollow component as claimed in claim 1, wherein deforming the internal structure comprises deforming the internal structure in a direction which is substantially parallel to a plane of the first or second panel.

3. A method of forming an internal structure within a hollow component as claimed in claim 1, wherein selectively bonding comprises applying a stop-off material to one or more portions of the at least one membrane and/or the first and second panels and diffusion bonding the component such that the membrane is bonded to the first and second panels except at the one or more portions where the stop-off material is applied.

4. A method of forming an internal structure within a hollow component as claimed in claim 1, wherein the at least one membrane is bonded to only one of the first and second panels.

5. A method of forming an internal structure within a hollow component as claimed in claim 4, wherein either side of the unbonded portion the membrane is bonded to the first or second panel.

6. A method of forming an internal structure within a hollow component as claimed in claim 4, wherein each of the one or more unbonded portions define a cavity between the membrane and the first or second panel.

7. A method of forming an internal structure within a hollow component as claimed in claim 1, wherein during inflation the pressurised fluid inflates the cavity between the membrane and the first or second panel so as to form the internal structure.

8. A method of forming an internal structure within a hollow component as claimed in claim 1, wherein during deformation the first pressure is applied to the cavity between the membrane and the first or second panel and the second pressure is applied between the membrane and the other of the first or second panel.

9. A method of forming an internal structure within a hollow component as claimed in claim 8, wherein the differential between the first pressure and the second pressure causes the internal structure to be deformed.

10. A method of forming an internal structure within a hollow component as claimed in claim 1, wherein the deformed internal structure creates a re-entrant feature.

11. A method of forming an internal structure within a hollow component as claimed in claim 1, wherein the at least one membrane comprises a first membrane and a second membrane and selectively bonding further comprises applying a stop-off material to the one or both of the opposing surfaces of the first and second membranes to prevent bonding of the first membrane to the second membrane.

12. A method of forming an internal structure within a hollow component as claimed in claim 1, wherein the die assembly comprises first and second dies each having a forming surface between which the aerofoil structure is placed; the method further comprising moving the die assembly to a second position and further inflating the component by passing a pressurised fluid between the first and second panels such that the first and second panels are inflated into contact with the die assembly in the second position, wherein the distance between at least a portion of the first and second dies is greater in the second position.

13. A method of forming an internal structure within a hollow component as claimed in claim 12, wherein the forming surface of the first and/or second dies has a section which is movable relative to the rest of the forming surface, and wherein moving the die assembly comprises moving the movable section to the second position.

14. A method of forming an internal structure within a hollow component as claimed in claim 11, wherein selectively bonding comprises selectively bonding the first membrane to the first panel and selectively bonding the second membrane to the second panel.

15. A method of forming an internal structure within a hollow component as claimed in any one of claim 11, wherein the first pressure is applied between the first membrane and the first panel and between the second membrane and the second panel, and the second pressure is applied between the first and second membranes.

16. A method of forming an internal structure within a hollow component as claimed in claim 11, wherein the pressurised fluid when further inflating the component is at a first pressure between the first membrane and the first panel and between the second membrane and the second panel, and at a second pressure between the first and second membranes, wherein the first pressure is lower than the second pressure.

17. A method of forming an internal structure within a hollow component as claimed in claim 11, further comprising providing a damping material between the first and second membranes.

18. A method of forming an internal structure within a hollow component as claimed in claim 1, wherein the hollow component is an aerofoil structure.

19. An aerofoil structure comprising first and second panels and first and second membranes disposed between the first and second panels, wherein the first membrane is selectively bonded to the first panel and the second membrane is selectively bonded to the second panel, wherein unbonded portions of the first and second membranes are formed into re-entrant features, the re-entrant features of the first or second membrane being spaced apart from the other of the first or second membrane.

20. An aerofoil structure as claimed in claim 19, wherein the re-entrant features of the first and second membranes are offset from one another.

21. An aerofoil structure as claimed in claim 19, wherein disposed between the first and second membranes is a damping material.

22. A turbomachine comprising an aerofoil structure as claimed in claims 19.

23. A die assembly for forming an aerofoil structure, the die assembly comprising:
first and second dies each having a forming surface between which the aerofoil structure is placed; wherein the forming surface of the first and/or second dies has a section which is movable relative to the rest of the forming surface.

24. A die assembly as claimed in claim 23, wherein the movable section is a central section of the forming surface.

25. A die assembly as claimed in claim 23, wherein the movable section is movable toward and away from a central axis between the first and second dies.

26. A die assembly as claimed in claim 23, wherein the movable section has a first and second position.

27. A die assembly as claimed in claim 23, wherein in the first position the aerofoil structure is inflated into contact with the forming surfaces of the first and second dies to form an internal structure and wherein in the second position the aerofoil structure is further inflated into contact with the forming surfaces of the first and second dies to take a final form of the aerofoil structure.

28. A method of forming an internal structure within an aerofoil structure using a die assembly, the aerofoil structure comprising first and second panels and at least one membrane disposed between the first and second panels and the die assembly comprising first and second dies each having a forming surface; wherein the forming surface of the first and/or second dies has a section which is movable relative to the rest of the forming surface, the method comprising:
selectively bonding the at least one membrane to the first and/or second panels;
locating the aerofoil structure between the forming surfaces of the first and second dies with the movable section in a first position inflating the aerofoil structure by passing a pressurised fluid between the first and second panels such that the first and second panels are inflated into contact with the forming surfaces of the first and second dies and such that the membrane forms an internal structure between the first and second panels;
deforming the internal structure by applying the pressurised fluid at a first pressure on one side of the membrane and at a second pressure on the other side of the membrane;
moving the movable section to a second position and further inflating the aerofoil structure such that the first and second panels are inflated into contact with the forming surfaces of the first and second dies.
